(19) United States
(12) Patent Application Publication
(10) Pub. No.: US 2010/0002761 A1
(43) Pub. Date: Jan. 7, 2010

(54) Method for using a network abstract layer unit to signal an instantaneous decoding refresh during a video operation

(75) Inventors: Purvin Bibhas Pandit, Franklin Park, NJ (US); Yeping Su, Vancouver, WA (US); Peng Yin, West Windsor, NY (US)

Correspondence Address: Robert D. Shedd, Patent Operations;THOMSON Licensing LLC, P.O. Box 5312, Princeton, NJ, 08543-5312, US

(73) Assignee: Thomson Licensing

(21) Appl. No.: 12/311,174

(22) PCT Filed: Oct. 16, 2007
(86) PCT No.: PCT/US2007/022082

§ 371 Date: Mar. 20, 2009

Related U.S. Application Data
(60) Provisional application No. 60/851,953, filed on Oct. 16, 2006.

(51) Int. Cl. H04N 7/12

(52) U.S. Cl. 375/240.01; 375/E07.076; 375/E07.027

(57) ABSTRACT

A memory management technique is defined for memory management for a memory used for storing reference pictures associated with a multiview coded video picture system. Based upon information received with coded picture information of an instantaneous refresh decode picture, a determination is made to delete reference pictures associated with a particular view, where such pictures to be deleted from the memory.

### CROSS-REFERENCE TO RELATED APPLICATIONS

This application claims the benefit of U.S. Provisional Application Ser. No. 60/851,953, filed Oct. 16, 2006, which is incorporated by reference herein.

### TECHNICAL FIELD

The present invention relates to the field of moving pictures, especially the issue of the storage of reference pictures used for coding a moving picture.

### BACKGROUND

Many interframe encoding systems make use of reference pictures where the use of such reference pictures helps reduce the size of an encoded bit stream. This type of result is encoding efficiency is better than just using intraframe encoding techniques, by themselves. Many encoding standards therefore incorporate both intraframe and interfame encoding techniques to encode a bit stream from a series of moving images. As known in the art, different types of reference pictures are used for encoding standards such as an “I” picture which is encoded only by using elements within the picture itself (intraframe), a “B” picture which is encoded by using elements from within the picture itself and/or elements from two previously coded reference pictures (interframe), and a “P” picture which is encoded by using elements from within the picture itself and/or elements from one previously reference picture (interframe). Both “B’ and “P” pictures can use multiple reference pictures, but the difference between both of these type of pictures is that “B” allows the use of inter prediction with at most two motion-compensated prediction signals per block while “P” allows the use of one only predictor per predicted block.

When the “B” or “P” pictures are being encoded and/or decoded, such pictures are therefore dependent on other reference frames so that such pictures may be properly encoded or constructed during a decoding operation. The encoding/decoding system should provide some type of memory location so that reference picture can be stored while other pictures are being encoded or decoded in view of such reference pictures. Obviously, after a while, a reference picture cannot be used for a coding operation because no more pictures to be coded will use the reference picture during the future coding operation.

Although, one could store all the reference pictures permanently in a storage device, such a solution would be an inefficient use of memory resources. Therefore, memory techniques such as using a First in First Out (FIFO) or Last in First Out (LIFO) memory operations, as known in the art, could be used in the case of operating a memory device with the storage of reference pictures to help reduce the space required for such reference pictures (by discarding unnecessary reference pictures). Such memory operations however may produce undesirable results when considering the use of an multiview coding system where pictures that are encoded and/or decoded have both a temporal and a view inter-relationship. That is, the multiview coding system introduces the aspect of having multiple views of moving pictures, where each view represents a different view of a respective object/scene. Now, a reference picture may be used in the encoding or decoding of pictures associated with two different views.

For example, FIG. 1 represents an exemplary embodiment of a reference picture structure used in a Multiview Video Coding system. Specifically, the presented structure pertains to the use of eight different views (S0-S7) for times (T0-T100) in accordance with the multiview encoding (MVC) scheme proposed in A. Vetro, Y. Su, H. Kimata, A. Smolic, “Joint Multiview Video Model (JMVM) 1.0”, JVT-T208.doc, Klagenfurt, Austria, July, 2006. This multiview encoding standard is based on coding in the Advanced Video Coding (AVC) standard (G. Sullivan, T. Wiegand, A. Luthra, “Draft of Version 4 of H.264/AVC (ITU-T Recommendation H.264 and ISO/IEC 14496-10 (MPEG-4 part 10) Advanced Video Coding)”, Palma de Mallorca, ES 18-22, October 2004). The large difference between both standards is AVC does not addresses coding multiview pictures while MVC does.

Referring back to FIG. 1, it can be seen for example that when coding a picture associated with view S1 at T1, that the picture to be coded is related to pictures (reference pictures) from the same view (S1 at T0 and S1 at T2), and that the picture to be coded is related to pictures from pictures from a different view (S0 at T1 and S2 at T1). Hence, when coding the picture associated with S1, T1, it would make sense to keep reference pictures (S1 at T0, S1 at T2, S0 at T1 and S2 at T1) in a memory device such as a buffer, register, RAM, and the like, where such decoded pictures would be stored in a device called a decoded picture buffer (DPB).

One way of managing reference pictures in a DPB is to make use of a syntax element (command) which can be generated externally and communicated to a coder to clear out part of the DPB. In the AVC specification, one could make use of the network abstract layer (NAL) where a command is inserted into the NAL in order to indicate an instantaneous decoding refresh (IDR) which is used to indicate that all of the stored reference pictures in the DPB are “unused for reference”. This means, that all of the reference pictures in the DPB should be eventually removed after an IDR is received. IDRs pictures can do this because they are associated with “I” or “SI” pictures (slices) which rely on intraframe coding (not interframe coding). Hence, typically the first picture in sequence of coded pictures is an IDR picture.

The current implementations of IDRs however are ineffective when addressing the issue of a MVC coding situation where multiple views may needed to be coded. For example, assume a view S0 is an AVC compatible view. If an AVC compatible ID picture is present at a time T16 in a view S0, it is not clear whether the only the reference pictures in view S0 should be marked as “unused for reference”. That is, under the current principles associated with IDR pictures for AVC and MVC, all stored reference pictures of any view in the DPB would be marked as “unused for reference” and removed from the DPB, which may not be a desirable result.

### SUMMARY

These and other drawbacks and disadvantages of the prior art are addressed by the present principles, which are directed to a method and apparatus for reusing available motion information as a motion estimation predictor for video encoding.

According to an aspect of the present principles, there is provided a coder used in for a multiview video coding environment that performs memory management operations on a decoded picture buffer, where such memory management operations will remove reference pictures associated with a particular view based upon control information.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 presents an exemplary embodiment multiview coding of video picture views at different times, where such video pictures are coded using reference pictures in the manner indicated in the figure.

FIG. 2 presents an embodiment of codes used for designating NAL units in accordance with the principles of the present invention.

FIG. 3 presents an embodiment of pseudo code for a syntax element ref_pic_list_reordering( ) used in accordance with the principles of the present invention.

FIG. 4 presents an embodiment of pseudo code for a syntax element mark_view_only( ) used in accordance with the principles of the present invention.

FIG. 5 discloses an exemplary embodiment of a coding system to be used in accordance with the principles of the present invention.

FIG. 6 is an exemplary embodiment of a coding for using IDR pictures in accordance with the principles of the present invention.

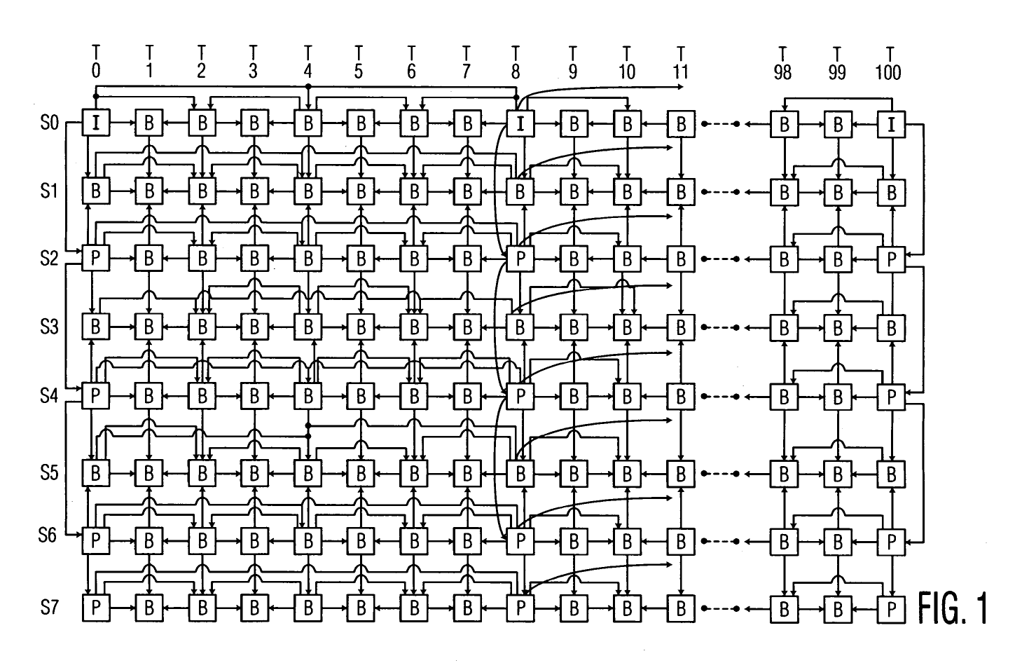

### DETAILED DESCRIPTION

The principles of the invention can be applied to any intra-frame and inter-frame based encoding standard. The term “picture” which is used throughout this specification is used as a generic term for describing various forms of video image information which can be known in the art as a “frame”, “field”, and “slice”, as well as the term “picture” itself. It should be noted that although the term picture is being used to represent various elements video information, AVC refers to the use of slices where such reference pictures may use slices from the same picture as a “reference picture”, and regardless of how a picture may be sub-divided, the principles of the present invention apply.

The principles of the invention below are typically described in conjunction with elements known as Network Abstract Layers, as defined in AVC. It is to be understood the principles of the invention also apply to a multitude of formats which are used to transmit data such as a data packet, comprising a header and a payload, a bit stream which interleaves both data and control packets, and the like.

Within the description of the invention, a reference picture is defined as coded video picture information which is used to code a picture. Within the operation of many video coding systems, a reference picture is stored in a memory such as the DPB. In order to fully manage what reference pictures to keep or delete, a DPB makes used of commands known as a memory management command operation (MMCO), which are used to assign memory statuses (typically by a coder) to stored reference pictures. For example, the memory statuses used for an AVC/MVC coder include the terms: short term reference picture, long term reference picture, or the picture is marked as unused as a reference picture (in which case the reference picture would be discarded if memory is needed from the DPB). The statuses of stored reference pictures may be changed as more pictures are coded, for example a reference picture that is designated as being a short term as one picture is being code picture can be identified as being a long term reference picture when a second picture is being coded.

Also, in the description of the present invention, various commands (syntax elements) which use the C language type of formatting are detailed in the figures that use the following nomenclature for descriptors in such commands:

u(n): unsigned integer using n bits. When n is “v” in the syntax table, the number of bits varies in a manner dependent on the value of other syntax elements.

The parsing process for this descriptor is specified by the return value of the function read_bits(n) interpreted as a binary representation of an unsigned integer with most significant bit written first.

ue(v): unsigned integer Exp-Golomb-coded syntax element with the left bit first.

se(v): signed integer Exp-Golomb-coded syntax element with the left bit first.

C: represents the category for which a syntax element applies to, i.e. to what level should a particular field apply.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

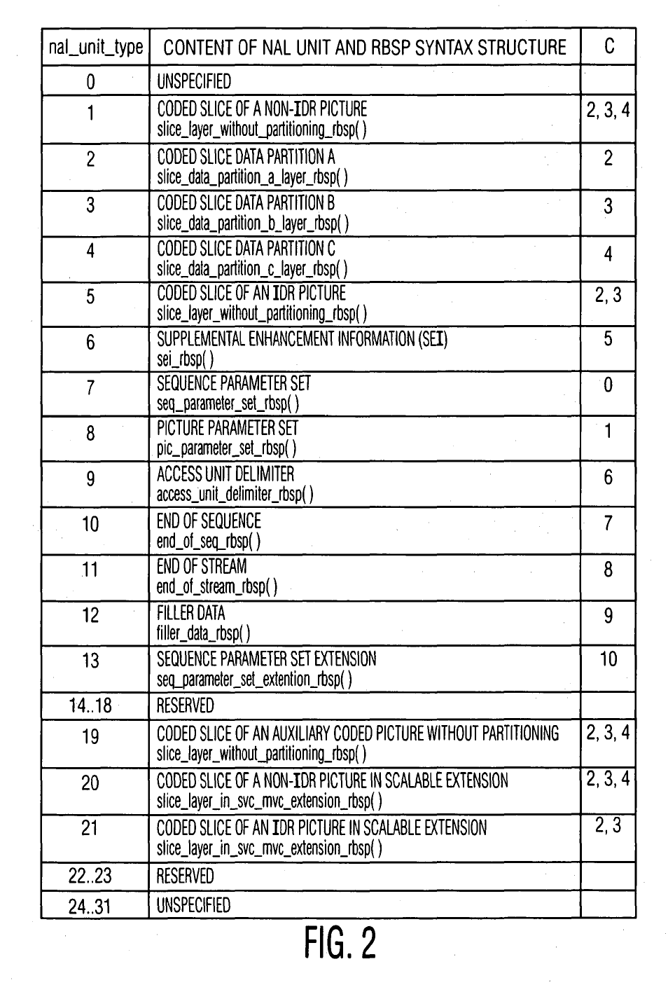

FIG. 2 discloses the syntax that is used for a NAL as used in AVC, where a AVC compatible bit stream contains coded pictures which use NAL units types of 1 or 5, as shown. MVC coded pictures make use of NAL unit types 20 and 21 for coded pictures. Both NAL unit types 1 and 20 represent non-IDR pictures (slices) for the respective video coding standards, while NAL units types 5 and 21 represent IDR pictures. When a coder receives the unit types of either 5 or 21 in a NAL (for instance in a bit stream), the coder will have the status of the reference pictures stored in the DBP changed to “unused for reference”.

In an embodiment of the present invention, it is proposed that a NAL unit called a suffix NAL unit be used with a NAL. A suffix NAL unit is defined as a NAL unit that follows another NAL unit in decoding order and contains descriptive information of the preceding NAL unit which is referred to as the associated NAL unit. Preferably, the following of the suffix NAL unit is immediately following the associated NAL unit.

As further defined, a suffix NAL unit shall have a nal_ref_idc equal to 20 or 21. When the svc_mvc_flag is equal to 0, the suffix NAL unit shall have a dependency_id and a quality_level both equal to 0, and shall not contain a coded slice. When svc_mvc_flag equals 1, the suffix NAL shall have a view_level equal to 0, and shall not contain coded picture information (slice), but control information may be included. A suffix NAL unit belongs to the same coded picture as the associated NAL unit.

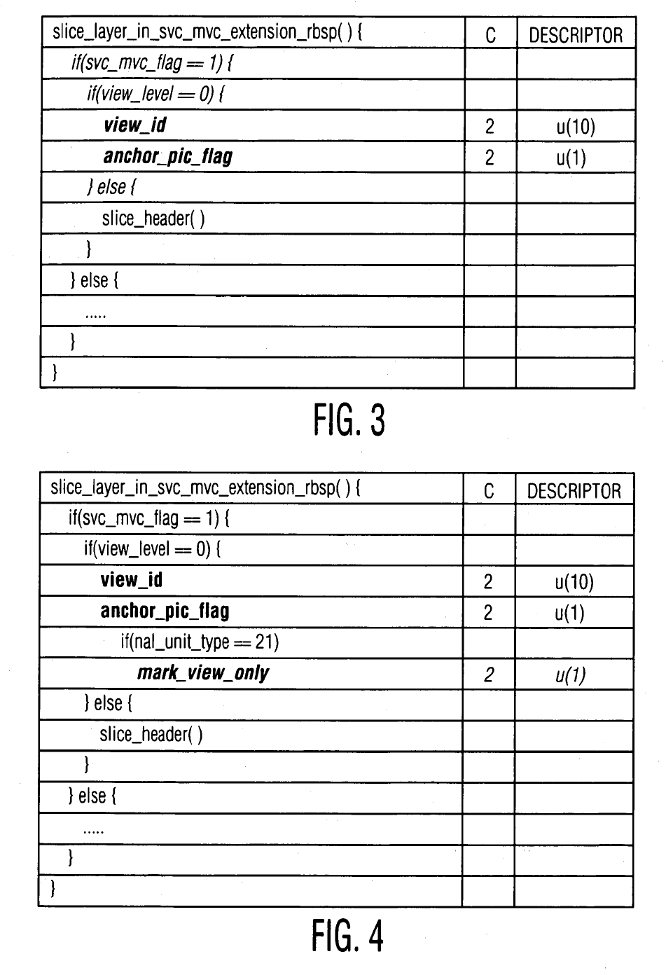

The syntax for a suffix NAL unit is shown in FIG. 3 defining the structure of a slice_layer_in_svc_mvc_extension_rbsp( ) function. This suffix NAL unit is capable of being used by a MVC compatible coder to extract information present in the NAL unit to obtain information about the associated NAL unit, and take the appropriate action.

Therefore, a new syntax is proposed where in the suffix NAL unit, information is present to indicate which view should be affected by the IDR call. That is, the new syntax will allow the stored reference pictures (in a DPB) that are for an associated view is marked as “unused for reference” while the stored reference pictures for another view retain their memory status.

A syntax element mark_view_only is proposed in an embodiment of the present invention and is shown in FIG. 4, which specifies the behavior in which an IDR picture will have on the DPB. When mark_view_only is equal to 1 in the suffix NAL unit, all of the reference pictures present in the DPB which are associated with a view associated with the view-id present in the same suffix NAL unit are marked as “unused for reference”. When the mark_view_only is equal to 0, all of the reference pictures present in the DPB are marked as “unused for reference”.

In an optional embodiment of the present invention, when an IDR picture is present in the MVC NAL units (type 21), it is proposed to impose the restriction that this IDR picture will only mark pictures in its own view as unused for reference.

In a further optional embodiment, a prefix NAL unit may be developed, where such a unit would be transmitted before the associated NAL unit. In a further optional embodiment, the type of command expressed above for selecting a particular view to associated an IDR with may be encapsulated in anywhere with a NAL unit where user data may be defined, as to append commands in accordance with the principles of the present invention.

It is also to be understood in an alternative embodiment of the present invention proposes that a control packet by itself may be deployed within a bit stream, where such a packet is used to indicate what reference pictures should be marked as “unused for reference”. Specifically, the control packet would contain a syntax such as remove_reference_view (or a command similar to this proposed command), where a value associated with the command indicates which stored reference pictures (via the associated view or views) to remove from a DPB.

This syntax may be developed to provide a control word which indicates which view or views should be removed from the DPB, at the same time. For example, if a video sequence has eight views (beginning with view 0) associated with it, the value used to remove the reference pictures associated with views (beginning with view 0) 1, 4, and 5 would be defined in accordance with an eight bit value such as (11001101). Such a value is derived where beginning from left to right; a view 0 is given the value “1”, which the reference pictures associated with view 0 are to be kept. Moving to the right for view 1, such a view is given a value “0”. Hence, within this embodiment of the present invention, the DPB would remove all of the reference pictures in the DPB that are associated with view 1. It is to be appreciated that other commands and values can be implemented by those of the skill in the art, in accordance the principles of this embodiment.

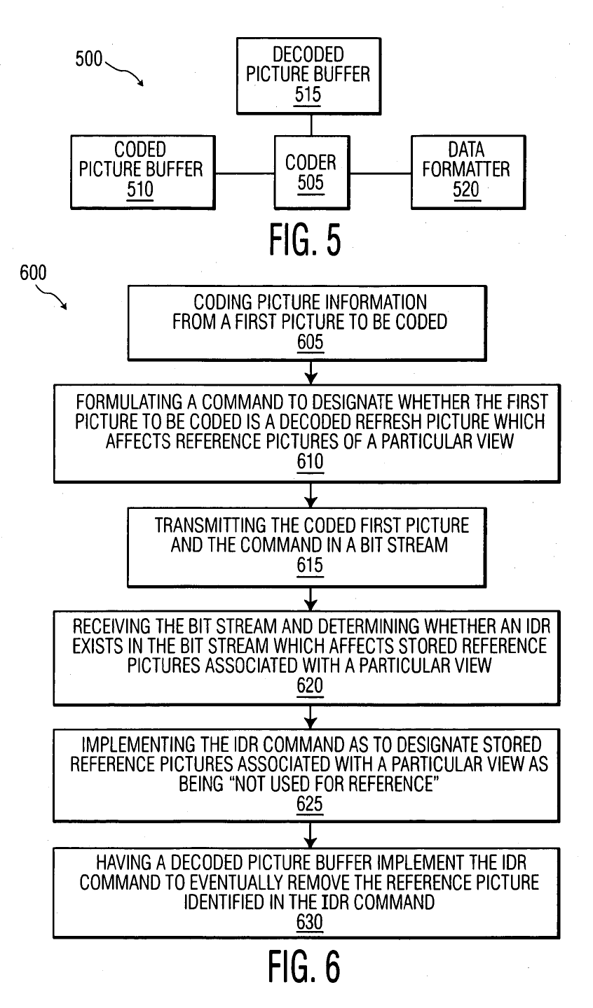

FIG. 5 discloses an exemplary embodiment of a coding system to be used in accordance with the principles of the present invention. In a simplified version of block diagram 500 in FIG. 5, the operation between a coder 505, coding buffer 510, and decoded picture buffer 515, and data formatter 520 is shown. During a coding operation (either encoding or decoding), a picture that is currently being coded by coder 505 is present in coding buffer 510, while previously coded reference pictures are stored in decoded picture buffer 515. As disclosed earlier, AVC discloses the use commands known as memory management control operations (MMCO) which allow the coder 505 to specify how the reference pictures in decoder picture buffer 515 should be maintained. That is, when a picture is being encoded, such MMCOs are inputted into the header of the picture presently being encoded as to specify what should be done with the reference pictures that came before such a picture. This operation is known as “marking”. These commands then can be used by the coder 505 in the future as to determine what should be done with a reference picture that is present in decoder picture buffer 515. It should be noted that although the term picture is being used to represent various elements video information, AVC refers to the use of slices where such reference pictures may use slices from the same picture as a “reference picture”, and regardless of how a picture may be sub-divided, the principles of the present invention apply.

Once pictures are encoded, they can be sent as part of a bit stream, where such data is formatted in a bit stream for transmission over a data network using data formatter 520. Preferably, data is transmitted in the form of NAL units which are further transmitted in a transport stream (such as IP packets, or an MPEG-2 Transport Stream, and the like), where data formatter 520 transmits the NAL units in transport packets. Data formatter 520 may therefore transmit both coded picture information and the commands addressed above as NAL units, where such NAL units can be prefix and/or suffix NAL units. Additionally, data formatter 520 may add the IDR information command within any user definable portion of a NAL unit. It is to be understood that data formatter 520 may also put the data commands addressed above in the header of a data packet, a payload of a data packet, or in a combination thereof of a transport packet.

In an exemplary embodiment of the present invention, data formatter 520 is capable of receiving a coded bit stream of transport packets, and formatting such received data into NAL units which are capable of being decoded by coder 505 into the form of decoded video picture data (as to construct a sequence of moving pictures). That is, data formatter 520 can read the NAL units to determine which pictures represent IDR pictures and/or coder 505 is the unit that is used to read the NAL data to mark reference pictures, associated with a particular view, as “not used for reference”. Coder 505 then operates in this optional embodiment, coder 505 is used to decode the received bit stream, where coding picture buffer 510 and decoded picture buffer 515 are to be used in accordance in the manner defined in regards to the AVC and MVC video coding standards.

FIG. 6 is an exemplary embodiment of the present invention disclosed within a flowchart 600, which is a method for using IDR pictures. In step 605, picture data for a picture to be encoded is processed by coder 505. As picture data is being encoded, coder 505 in step 610 adds a command designating whether the picture being coded will represent an instantaneous decoding refresh picture. Part of this command will indicate whether the picture (if it is an IDR), will affect either all of the reference pictures that are stored (or are to be stored in DPB 515), or whether the stored reference pictures associated with a particular view are to be marked as “not used for reference”.

Data formatter 520 uses the command developed by the coder in step 610, and transmits such an IDR command in a NAL (preferably as a suffix NAL, as described above, although other transmission formats may be used, in accordance with the principles of the invention) in step 615.

In step 620, a similar data formatter 520 receives the coded data stream, where the data formatter reads the NAL to determine whether the received NAL represents an IDR, and what stored reference pictures (as identified by view) would be affected by the IDR operation. In step 625, coder 505 as it decodes the coded picture information from a received associated NAL (in a preferred embodiment), implements the IDR command to mark the stored reference pictures as “not used for reference” as identified in the suffix NAL by view. In step 630, DPB 515 implements such a command and marks the stored reference pictures selected in the IDR command as “not used as reference”, where DPB 515 will eventually remove such reference pictures.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage, unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method for coding video data corresponding to a sequence of moving pictures comprising the steps of:
coding video information corresponding to a video picture, wherein said video picture corresponds to at least one view of a multiview;
generating information indicating whether at least one stored reference picture of a second view of a multiview is to be deleted.

2. The method of claim 1 comprising the additional steps of:
transmitting said coded video information and said information indicating whether a stored reference picture should be deleted.

3. The method of claim 2, wherein said transmission step transmits said coded video information in a first network abstraction layer (NAL) unit and said generated information in a second NAL unit.

4. The method of claim 3, wherein said first NAL unit is an associated NAL unit and second NAL is a suffix NAL unit.

5. The method of claim 2, wherein said transmission step transmits said coded video information in a payload of a transport packet and said information indicated at least one stored reference of a second view is to be deleted.

6. The method of claim 1, wherein said first and second view are different views of a multiview.

7. The method of claim 1, wherein said first and second views are the same view of a multiview.

8. The method of claim 1, wherein said information indicating whether a stored reference picture of a second view it to be deleted marks such a reference picture as “unused for reference”.

9. The method of claim 1, wherein further information is generated and transmitted which indicates whether a stored reference picture of a third view, which is different than said first and second views, should be deleted.

10. The method of claim 1, wherein said coded picture is an instantaneous refresh decode picture.

11. A method for decoding a received bit stream representing a multiview sequence of video pictures comprising the steps of:
processing information in said bit stream as to decode coded video picture information associated with a first view of a multiview;
determining whether said information exists in said bit stream which requires the deletion of at least one stored reference picture associated with a second view of a multiview.

12. The method of claim 11, comprising the additional step of:
deleting said at least one reference picture associated with a second view from a memory.

13. The method of claim 12, wherein said deletion step is performed because said at least one reference picture is denoted as being “unused for reference”.

14. The method of claim 12, comprising the additional step of:
retaining in said memory at least one reference picture associated with a third view from a memory, wherein said second view and third view represent different views.

15. The method of claim 14, wherein said memory is a decoded picture buffer.

16. The method of claim 11, wherein said information indicates that said coded picture is an instantaneous refresh decode picture.

17. The method of claim 1, wherein said first view and said second views are the same view.
